(19) United States
(12) Patent Application Publication
(10) Pub. No.: US 2011/0087383 A1
(43) Pub. Date: Apr. 14, 2011

(54) NETWORK PROTECTION WITH CONTROL HEALTH MONITORING

(75) Inventor: Mark Andre FAULKNER, Greenwood, SC (US)

(73) Assignee: EATON CORPORATION, Cleveland, OH (US)

(21) Appl. No.: 12/575,782

(22) Filed: Oct. 8, 2009

(51) Int. Cl. G05B 9/02

(52) U.S. Cl. 700/293; 700/292

(57) ABSTRACT

Apparatus and methods for network protection monitor the functional state of a control component on a circuit protection device and provide a back up control signal to activate the circuit protection device to protect the network in the event that the control component on the circuit protection device stops functioning.

### BACKGROUND

In modern power delivery systems, microprocessor controlled electronic relays are replacing electro-mechanical relays in network circuit protection devices. While the electronic relays offer expanded functionality such as programmability, the electronic relays are susceptible to damage from high transient excursions that are common in power delivery systems. An electronic control relay in a network protection device that has become inoperable often goes undetected and may result in failure of the circuit protection device and damage to the network components the circuit protection device is intended to protect.

### SUMMARY

Apparatus and methods for network protection monitor the functional state of a control component on a circuit protection device and provide a back up control signal to activate the circuit protection device to protect the network in the event that the control component on the circuit protection device stops functioning.

One example apparatus includes a health signal input receiver configured to be placed in signal communication with a control component that controls operation of a circuit protection device that protects an electrical circuit. The control component may be, for example, a microprocessor controlled electronic relay, or any other component that activates a circuit protection device. The health signal is indicative of a present functional state of the control component. The health signal may be, for example, a programming interface power supply voltage provided by the control component to power a programming pendant that is connected to the control component to program the control component. The health signal may also include a repeating serial health stream signal that is output by the control component. The apparatus includes a processor in signal communication with the health signal input receiver that is operable to input the health signal for processing and to selectively output a control signal when the health signal indicates that the component is not functional. A first circuit protection device actuator is in signal communication with the processor. The actuator is responsive to the control signal to activate the circuit protection device.

Another example apparatus includes a first voltage signal input receiver configured to be placed in signal communication with the electrical circuit to receive a voltage signal that is indicative of a presence of voltage on the electrical circuit. In this example apparatus, the processor is operable to input the voltage signal and to output the control signal when the health signal indicates that the component is not functional and the voltage signal indicates that voltage is present on the electrical circuit. Some example apparatuses include a surge protector configured to create a parallel ground path to an input on the control component. The surge protector includes a surge protection device, such as, for example, a metal oxide varistor.

In one particular apparatus, the first voltage signal input receiver is configured to receive a voltage signal that is indicative of the presence of voltage on a transformer side of the electrical circuit and the apparatus includes a second voltage signal input receiver. The second voltage signal input receiver is configured to be placed in signal communication with the electrical circuit to receive a second voltage signal that is indicative of a presence of voltage on a network side of the electrical circuit. The apparatus also includes a second circuit protection device actuator in circuit communication with the processor. The second circuit protection device is responsive to the control signal to control the circuit protection device to prevent an automatic reset of the circuit protection device due to voltage being absent on the network side of the electrical circuit after the circuit protection device is activated.

An example method includes receiving the health signal from a control component and determining a present functional state of the control component based, at least in part, on the health signal. A first control signal is output to the circuit protection device to activate the circuit protection device when it is determined that the control component is not functional. In another example method, a first voltage signal is received that is indicative of a presence of voltage on the electrical circuit. The present functional state of the control component is determined based, at least in part, on the first voltage signal. A first control signal is output to the circuit protection device to activate the circuit protection device when it is determined that the control component is not functional.

In one particular method, the first voltage signal is indicative of the presence of voltage on a transformer side of the electrical circuit and the method includes receiving a second voltage signal that is indicative of a presence of voltage on a network side of the electrical circuit. The present functional state of the control component is determined based, at least in part, on the second voltage signal. The first control signal is output to the circuit protection device to activate the circuit protection device when it is determined that that the control component is not functional. A second control signal is output when it is determined that the control component is not functional. The second control signal is configured to control the circuit protection device to prevent an automatic reset of the circuit protection device due to voltage being absent on the network side of the electrical circuit after activation of the circuit protection device.

### BRIEF DESCRIPTION OF THE DRAWINGS

The accompanying drawings, which are incorporated in and constitute a part of the specification, illustrate various example systems, methods, and other example embodiments of various aspects of the invention. It will be appreciated that the illustrated element boundaries (e.g., boxes, groups of boxes, or other shapes) in the figures represent one example of the boundaries. One of ordinary skill in the art will appreciate that in some examples one element may be designed as multiple elements or that multiple elements may be designed as one element. In some examples, an element shown as an internal component of another element may be implemented as an external component and vice versa. Furthermore, elements may not be drawn to scale.

FIG. 1 is a schematic diagram of an example embodiment of a network protection system that includes control relay health monitoring.

FIG. 2 is a schematic diagram of an example embodiment of a network protection system that includes control relay health monitoring.

FIG. 3 is a schematic diagram of an example embodiment of a network protection system that includes control relay health monitoring.

FIG. 4 is a flow diagram of an example method for network protection with control relay health monitoring.

FIG. 5 is a flow diagram of an example method for network protection with control relay health monitoring.

FIG. 6 is a flow diagram of an example method for network protection with control relay health monitoring.

### DETAILED DESCRIPTION

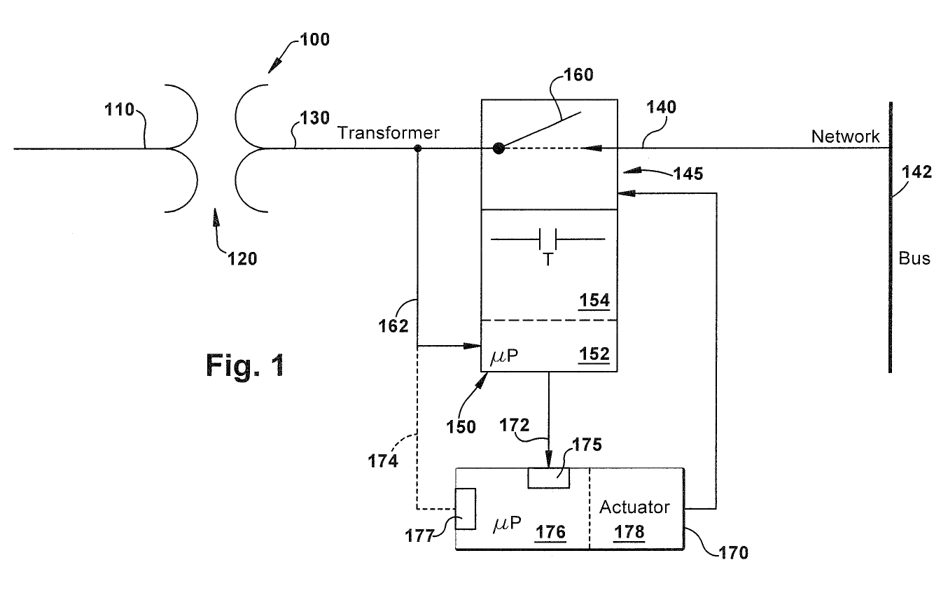

FIG. 1 illustrates a functional block diagram of an example electrical circuit 100 that includes network protection with control health monitoring. The electrical circuit 100 includes a transformer 120 that is disposed between a medium voltage feeder line 110 and a transformer side 130 of the electrical circuit. In the illustrated example, the medium voltage feeder line has a voltage of approximately 15 Kilovolts AC and the transformer voltage is approximately 480 Volts AC on three phases. While only one feeder line 110 is illustrated in FIG. 1, it is to be appreciated that methods and apparatuses described herein may be used in connection with any or all feeder lines in a given network. The electrical circuit 100 also includes a network side 140 that is connected to at least one network bus 142. A circuit protection system 145 functionally divides the transformer side 130 of the electrical circuit 100 from the network side 140 of the electrical circuit. The circuit protection system 145 is configured to protect the network bus 142 by disconnecting the network side 140 from the transformer side 130 upon the occurrence of certain events, such as, for example, reverse real power flowing toward the transformer 120.

The circuit protection system 145 includes a circuit protection device 160 that is capable of electrically disconnecting the network side 140 from the transformer side 130. The circuit protection device 160 may be, for example, a set of electrical contacts. The circuit protection device 160 is activated by a control component 150 that provides a trip signal to the circuit protection by way of, for example, a control relay 154. In the illustrated example, the control component 150 is a microprocessor controlled electronic relay that includes the control relay 154 and a programmable microprocessor 152.

A control health monitoring and network protection apparatus 170 provides back up network protection by monitoring the functional status of the control component 150 and activating the circuit protection device 160 when the control component 150 is not functional. Thus the control health monitoring and network protection apparatus 170 is able to detect when the control component 150 is not capable of triggering the circuit protection device 160 prior to an event occurring in the electrical circuit 100 that would call for activation of the circuit protection device. The control health monitoring and network protection apparatus 170 monitors the functional status of the control component 150 by monitoring a health signal 172 from the control component. In the illustrated example, the health signal is a programming interface power supply voltage, such as, for example, a 5 Volt signal from an RS232 port that is used to power a programming pendant used to program the microprocessor 152. In some embodiments, the health signal may also include a repeating serial health stream signal that is output by the microprocessor 172.

The control health monitoring and network protection apparatus 170 includes a processor 176, an actuator 178, and a health signal input receiver 175 that is configured to receive the health signal. The processor inputs the health signal and selectively outputs a control signal (not shown) to the actuator 178 when the health signal indicates that the control component is not functional. The actuator 178 is configured to activate the circuit protection device 160 in response to the control signal. Thus, in the illustrated example, the control health monitoring and network protection apparatus 170 opens the circuit protection device 160 when it is detected that the control component 150 is malfunctioning and may not be capable of controlling the circuit protection device 160.

The control health monitoring and network protection apparatus 170 may also include a voltage signal input receiver 177 that receives a voltage signal that is indicative of a presence of voltage in the electrical circuit 100. In this case, the processor 176 outputs the control signal when the health signal 172 indicates that the control component is not functional and when there is voltage in the electrical circuit 170. Monitoring the voltage signal as well as the health signal allows the control health monitoring and network protection apparatus 170 to avoid nuisance activations of the circuit protection device, such as opening the circuit protection device 160 when the electrical circuit is not in use.

Thus, the control health monitoring and network protection apparatus 170 may provide means (e.g., hardware, firmware) for receiving a health signal from a control component that controls operation of a circuit protection device that protects an electrical circuit. The control health monitoring and network protection apparatus 170 may provide means (e.g., hardware, firmware) for receiving a voltage signal that is indicative of a presence of voltage on the electrical circuit and means for determining a health of a control component that controls operation of a circuit protection device that protects an electrical circuit. The means may be implemented, for example, as an ASIC programmed to determine the health of the control component based, at least in part, on the health signal and voltage signal. The means may also be implemented as computer executable instructions that are presented to the processor 176 as data that are temporarily stored in processor memory and then executed by processor 176.

The control health monitoring and network protection apparatus 170 may provide means for outputting a first control signal configured to activate the circuit protection device when the control component is determined to be not functional.

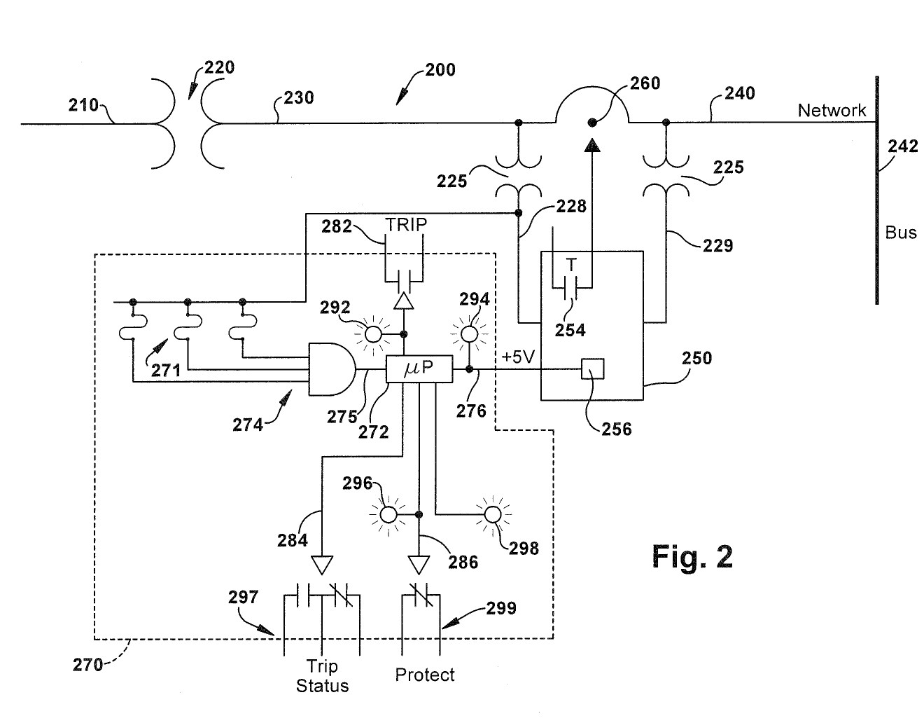

FIG. 2 illustrates an electrical circuit 200 that includes a transformer 220, a feeder line 210, a transformer side 230, and a network side 240. A circuit protection device 260 is placed between the transformer side 230 and the network side 240. The circuit protection device 260 is controlled by a control component 250, which may be a microprocessor controlled electronic relay. The control component includes a programming interface port 256 configured to connect to a programming pendant. For example, the programming interface port may be an RS232 port. The programming interface port provides a power supply voltage to a programming pendant such that there is a constant voltage, typically around 5 VDC, present at the interface port.

The control component provides a trip signal to the circuit protection device by way of a trip relay 254. The control component 250 is isolated from the electrical circuit by transformers 225 that step the line voltage in the electrical circuit down. For example, a 480 Volt three phase voltage on the electrical circuit may be stepped down to 125 Volts AC. The control component 250 inputs the stepped down transformer side voltage 228 and network side voltage 229 to determine when to activate the circuit protection device 260. Even though the control component 250 is isolated from the relatively high voltage in the electrical circuit 300, the control component is still exposed to high transient excursions that commonly occur in electrical power delivery systems. In some instances the control component becomes inoperable due to a transient or another reason, leaving the circuit protection device without a triggering means and the electrical circuit susceptible to damage due to a reverse current or other circuit malfunction.

A control health monitoring and network protection apparatus 270 is electrically connected to the control component 250 and the transformer side 230 of the electrical network. The control health monitoring and network protection apparatus 270 includes a microprocessor 272 that controls a trip actuator 282. The trip actuator is configured to activate the circuit protection device 260 by providing a control signal similar to the signal that is provided by the control relay 254. Hence, the output of the trip actuator 282 may be provided as a parallel input to the circuit protection device 260. In the illustrated example, the trip actuator 282 is a set of normally open dry contacts.

The microprocessor 272 monitors a health signal 276 from the control component 250. In the illustrated embodiment, the health signal is the programming interface power supply voltage from the programming interface port 256. For example, the health signal may be the 5 VDC power supply voltage in an RS232 connection port on the control component 250. The health signal may also include a repeating serial health stream signal that is output by the control component. The microprocessor 272 also monitors all three phases of the stepped down transformer side voltage 225. A thermal fuse 271 is present in the input path for each voltage phase to protect the microprocessor 272.

The microprocessor 272 is programmed to send a control signal to the trip actuator 282 if the health signal is not present and all three phases of the stepped down transformer side voltage 228, which are logically ANDed together to create a first voltage signal 275, are present. This combination of trip conditions indicates that the electrical circuit 200 is active while the control component 250 is not functioning. The microprocessor 272 will typically be programmed to delay activation of the circuit protection device 260 for at least one second from when the trip conditions are first detected to reduce the likelihood of nuisance trips during network start up or due to signal noise. While the logical AND function is depicted as occurring outside of the microprocessor 272, this function may be performed by the microprocessor.

The control health monitoring and network protection apparatus 270 may also include a trip status output 297 and a protect status output 299. The trip status output 297 indicates the status of the control health monitoring and network protection apparatus 270 by providing an output that indicates that the control component is not functioning. In the illustrated example, the trip status output is a set of normally open, normally closed, and common dry contacts. The protect status output 299 indicates the status of the control health monitoring and network protection apparatus 270 by providing an output that indicates that a thermal fuse 271 has opened. The protect status output may also be triggered to indicate that the apparatus 270 is not protecting the network by abnormally low bus voltages or an absence of bus voltages. Of course other network conditions may also be appropriate triggers for any of the status outputs. In the illustrated embodiment, the protect status output is a set of normally closed and common dry contacts.

The control health monitoring and network protection apparatus 270 may include one or more status indicating LEDs. In the illustrated example, a first LED 292 is illuminated red when the control health monitoring and network protection apparatus 270 has detected a problem with the control component and activated the circuit protection device. A second LED 294 is illuminated green when the health signal is present. A third LED 296 is illuminated green unless a thermal fuse is open, or abnormally low bus voltages or an absence of bus voltages is detected. A fourth LED 298 blinks green when the processor 272 is running properly.

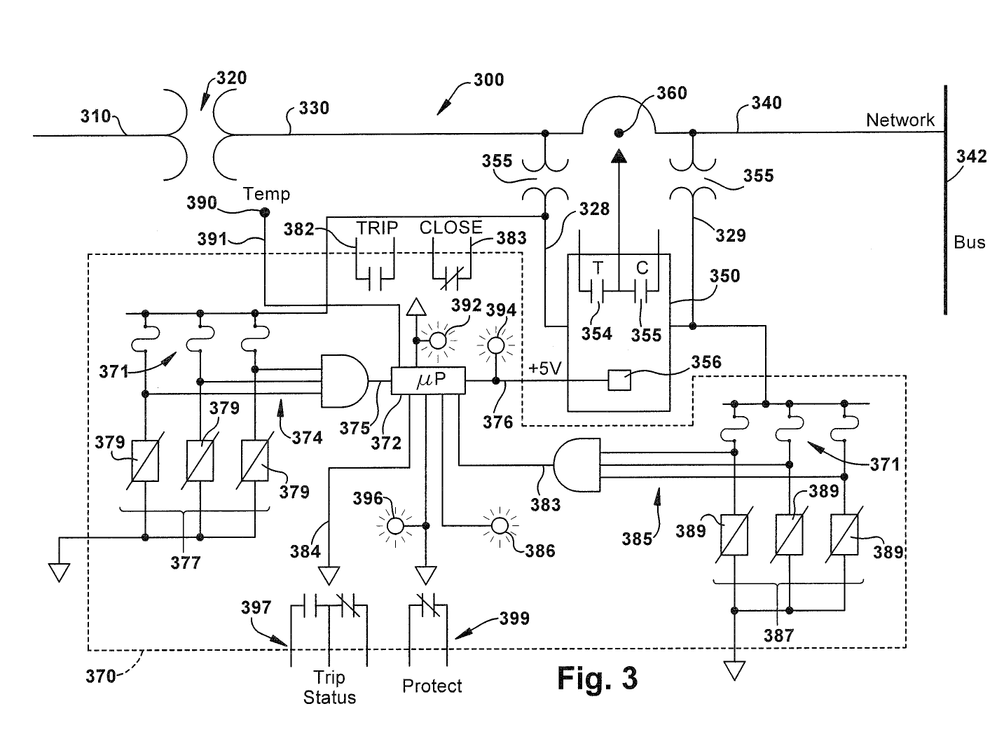

FIG. 3 illustrates an example control health monitoring and network protection apparatus 370 installed in an electrical circuit 300. The electrical circuit 300 and the control health monitoring and network protection apparatus 370 include many of the features and components described in connection with the control health monitoring and network protection apparatus 270 illustrated in FIG. 2. For example, the electrical circuit 300 includes a circuit protection device 360 that functions in a similar manner to the circuit protection device 260 in FIG. 2. The components in FIG. 3 that have a similar or analogous counterpart in FIG. 2 will not be described in detail here, however, these components have been given reference numbers with the same tens and ones digits as their counterpart in FIG. 2. The control health monitoring and network protection apparatus 370 includes additional components and features such as surge protection functionality and an additional close output 383 that may be used depending on the type of control component 350 on which the apparatus is installed.

The control health monitoring and network protection apparatus 370 includes a microprocessor 372 that inputs a health signal 376 and three phases of a stepped down transformer side voltage 328. The control health monitoring and network protection apparatus 370 includes a surge protector 377 that creates a parallel ground path with respect to the input for a first voltage signal 375 to the microprocessor 372. The parallel ground path includes surge protection devices 379 for each voltage phase. In the illustrated embodiment, the surge protection devices 379 are metal oxide varistors.

The control health monitoring and network protection apparatus 370 is adapted for use with a particular type of control component 350 that provides a reset or close signal to the circuit protection device 360 after the circuit protection device 360 has been activated. This reset signal is provided to the circuit protection device by way of a close relay 355. To defeat this automatic reset function, the control health monitoring and network protection apparatus 370 includes a close actuator 383 that controls the circuit protection device to remain in a tripped condition instead of resetting. In the illustrated embodiment, the close actuator is a set of normally closed dry contacts.

The microprocessor 372 inputs a second voltage signal 383 corresponding to a logical AND of each of three phases of a stepped down network voltage 329. A surge protector 387 with surge protection devices 389 is installed on the network side in a similar manner to that discussed with respect to the surge protector 379. The microprocessor is programmed to send a control signal to the trip actuator 382 and the close actuator 383 when the health signal is not present and when all three phases of the stepped down transformer side voltage 328 and all three phases of the stepped down network side voltage 329 are present. The microprocessor 382 will typically be programmed to delay activation of the circuit protection device 360 for at least one second from when the trip conditions are first detected to reduce the likelihood of nuisance trips during network start up or due to signal noise.

The control health monitoring and network protection apparatus 370 includes an external temperature sensor 390 that senses the temperature inside an enclosure in which the circuit protection device 360 and network side 340 are enclosed. The temperature sensor sends a temperature signal 391 to the microprocessor 372 and the microprocessor is programmed to control the trip actuator 382 to activate the control protection device when the temperature inside the enclosure exceeds a threshold. In this manner, the control health monitoring and network protection apparatus 370 can activate the circuit protection device in the event of a fire in the enclosure, which is a condition that is not typically detected by traditional control components.

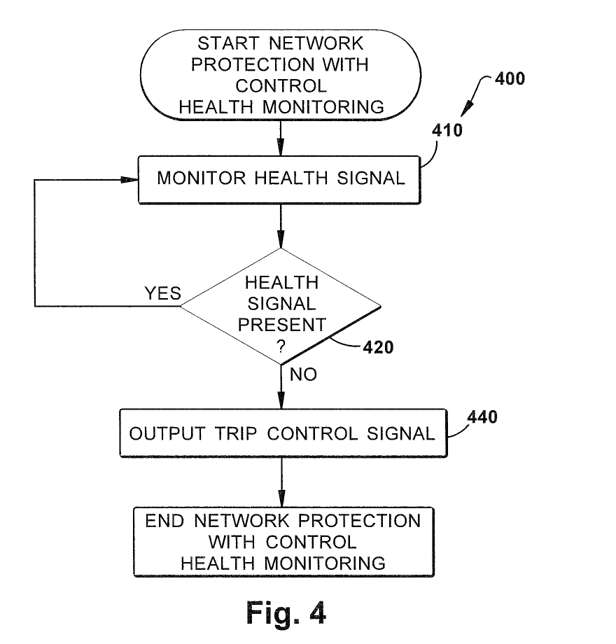

FIG. 4 is a flow diagram that illustrates a method of providing network protection with control health monitoring. At 410, the health signal is monitored. The health signal may be, for example, a programming interface power supply voltage. At 420, if the health signal is present, the monitoring continues at 410. If the health signal is not present, at 440 a trip control signal is output. The trip control signal may control a trip actuator to activate a circuit protection device.

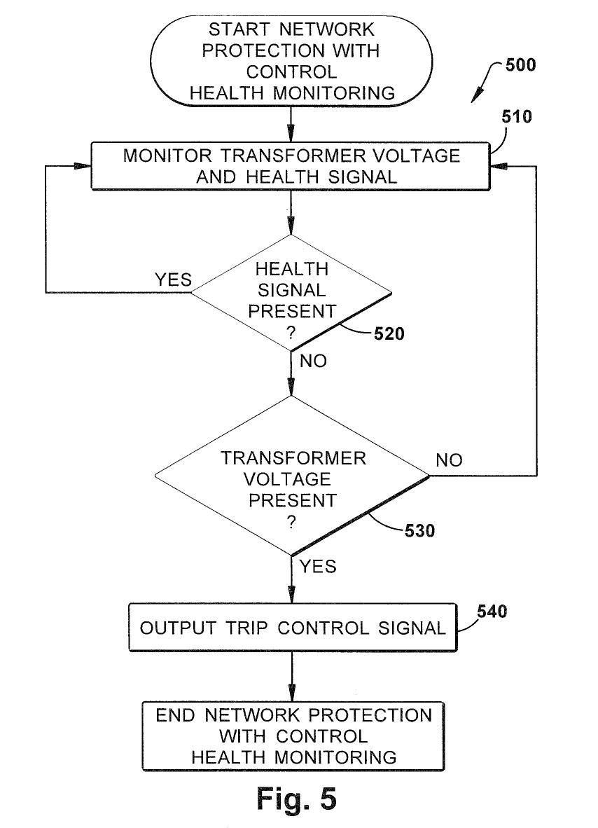

FIG. 5 is a flow diagram that illustrates a method of providing network protection with control health monitoring. At 510, the health signal and transformer side voltage are monitored. The health signal may be, for example, a programming interface power supply voltage. At 520, if the health signal is present, the monitoring continues at 510. If the health signal is not present, at 530 it is determined whether the transformer voltage signal is present and if the transformer voltage signal is not present, the monitoring continues at 510. If the transformer voltage is present at 530 at 540 a trip control signal is output. The trip control signal may control a trip actuator to activate a circuit protection device.

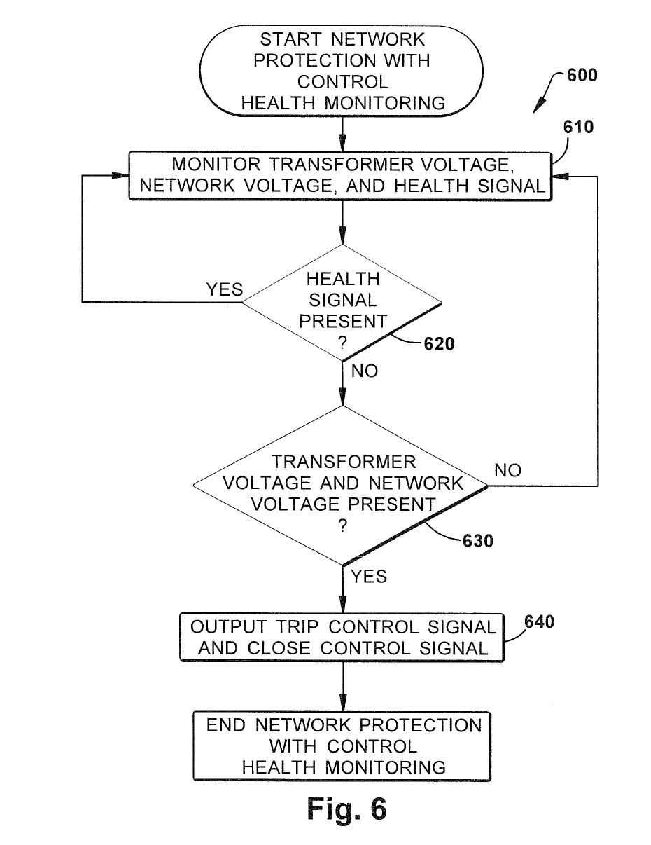

FIG. 6 is a flow diagram that illustrates a method of providing network protection with control health monitoring. At 610, the health signal, transformer side voltage and network side voltage are monitored. The health signal may be, for example, a programming interface power supply voltage. At 620, if the health signal is present, the monitoring continues at 610. If the health signal is not present, at 630 it is determined whether the transformer voltage signal and network side voltage are present and if the transformer voltage signal and network side voltage are not present, the monitoring continues at 610. If the transformer voltage and network side voltage are present at 630 at 640 a trip control signal and a close control signal are output. The trip control signal may control a trip actuator to activate a circuit protection device while the close control signal may defeat an automatic reset of the circuit protection device.

While example systems, methods, and so on have been illustrated by describing examples, and while the examples have been described in considerable detail, it is not the intention of the applicants to restrict or in any way limit the scope of the appended claims to such detail. It is, of course, not possible to describe every conceivable combination of components or methodologies for purposes of describing the systems, methods, and so on described herein. Therefore, the invention is not limited to the specific details, the representative apparatus, and illustrative examples shown and described. Thus, this application is intended to embrace alterations, modifications, and variations that fall within the scope of the appended claims.

To the extent that the term “includes” or “including” is employed in the detailed description or the claims, it is intended to be inclusive in a manner similar to the term “comprising” as that term is interpreted when employed as a transitional word in a claim.

What is claimed is:

1. An apparatus comprising:
a health signal input receiver configured to be placed in signal communication with a control component that controls operation of a circuit protection device that protects an electrical circuit, where the health signal is indicative of a present functional state of the control component;
a processor in signal communication with the health signal input receiver, the processor operable to:
input the health signal for processing; and
selectively output a control signal when the health signal indicates that the control component is not functional; and
a first circuit protection device actuator in signal communication with the processor, the actuator being responsive to the control signal to activate the circuit protection device.

2. The apparatus of claim 1 further comprising:
a first voltage signal input receiver configured to be placed in signal communication with the electrical circuit to receive a voltage signal that is indicative of a presence of voltage on the electrical circuit, and
where the processor is further operable to input the voltage signal and to output the control signal when the health signal indicates that the component is not functional and the voltage signal indicates that voltage is present on the electrical circuit.

3. The apparatus of claim 1 where the health signal is a programming interface power supply voltage on the control component and where the health signal receiver comprises a connection port configured to receive the power supply voltage.

4. The apparatus of claim 1 where the health signal includes a repeating serial health stream signal that is output by the control component.

5. The apparatus of claim 1 further comprising a surge protector configured to create a parallel ground path to an input on the control component that includes a surge protection device.

6. The apparatus of claim 6 where the surge protection device comprises a metal oxide varistor.

7. The apparatus of claim 1 where the first voltage signal input receiver is configured to receive a voltage signal that is indicative of the presence of voltage on a transformer side of the electrical circuit, the apparatus further comprising:
a second voltage signal input receiver configured to be placed in signal communication with the electrical circuit to receive a second voltage signal that is indicative of a presence of voltage on a network side of the electrical circuit; and
a second circuit protection device actuator in circuit communication with the processor, the second circuit protection device actuator being responsive to the control signal to control the circuit protection device to prevent an automatic reset of the circuit protection device due to voltage being present on the network side of the electrical circuit.

8. The apparatus of claim 1 comprising:
a temperature sensor in signal communication with the processor, the temperature sensor configured to sense a temperature outside the apparatus;
the processor being operable to output the control signal when the temperature sensed by the temperature sensor exceeds a threshold.

9. A method comprising:
receiving, with a processor, an electronic health signal from a control component that controls operation of a circuit protection device that protects an electrical circuit, where the health signal is indicative of control component operation;
determining, with the processor, a present functional state of the control component based, at least in part, on the health signal; and
outputting a first control signal to the circuit protection device to activate the circuit protection device when the processor determines that the control component is not functional.

10. The method of claim 8 where the receiving is performed by monitoring a programming interface supply voltage on the control component.

11. The method of claim 8 comprising:
receiving, with a processor, a first voltage signal that is indicative of a presence of voltage on the electrical circuit;
determining, with the processor, a present functional state of the control component based, at least in part, on the first voltage signal; and
outputting the first control signal to the circuit protection device to activate the circuit protection device when the processor determines that the control component is not functional.

12. The method of claim 11 where the first voltage signal is indicative of the presence of voltage on a transformer side of the electrical circuit.

13. The method of claim 11 where the determining is performed by determining that the control component is not functional when the first voltage signal indicates the presence of voltage on the electrical circuit and the health signal indicates that the control component is not operating.

14. The method of claim 12 comprising:
receiving, with a processor, a second voltage signal that is indicative of a presence of voltage on a network side of the electrical circuit;
determining, with the processor, a present functional state of the control component based, at least in part, on the second voltage signal; and
outputting the first control signal to the circuit protection device to activate the circuit protection device when the processor determines that the control component is not functional.

15. The method of claim 14 where the determining is performed by determining that the control component is not functional when the second voltage signal indicates the presence of voltage on the network electrical circuit and the health signal indicates that the control component is not operating.

16. The method of claim 15 comprising outputting a second control signal when the processor determines that the control component is not functional, the second control signal being configured to control the circuit protection device to prevent an automatic reset of the circuit protection device due to voltage being present on the network side of the electrical circuit.

17. One or more computer-readable media having stored thereon computer executable instructions, that when executed perform a method, the method comprising:
receiving an electronic health signal from a control component that controls operation of a circuit protection device that protects an electrical circuit, where the health signal is indicative of control component operation;
receiving a first voltage signal that is indicative of a presence of voltage on the electrical circuit;
determining a present functional state of the control component based, at least in part, on the health signal and the voltage signal; and
when the control component is determined to be not functional, outputting a first control signal configured to activate the circuit protection device.

18. The one or more computer-readable media of claim 17 where the receiving is performed by monitoring a programming interface supply voltage on the control component.

19. The one or more computer-readable media of claim 17 where the first voltage signal is indicative of the presence of voltage on a transformer side of the electrical circuit.

20. The one or more computer-readable media of claim 17 where the determining is performed by determining that the control component is not functional when the first voltage signal indicates the presence of voltage on the electrical circuit and the health signal indicates that the control component is not operating.

21. The one or more computer-readable media of claim 19 comprising:
receiving a second voltage signal that is indicative of a presence of voltage on a network side of the electrical circuit;
determining that the control component is not functional when the first voltage signal indicates the presence of voltage on the transformer side, the second voltage signal indicates the presence of voltage on the network side of the electrical circuit, and the health signal indicates that the control component is not operating; and
when the control component is determined to be not functional, outputting a second control signal configured to control the circuit protection device to prevent an automatic reset of the circuit protection device due to voltage being present on the network side of the electrical circuit.

22. A system comprising:
means for receiving a health signal from a control component that controls operation of a circuit protection device that protects an electrical circuit;
means for receiving a first voltage signal that is indicative of a presence of voltage on the electrical circuit;
means for determining a present functional state of the control component based, at least in part, on the health signal and the voltage signal; and
means for outputting a first control signal configured to activate the circuit protection device when the control component is determined to be not functional.

23. The system of claim 22 comprising means for providing surge protection to the control component.
